(19) United States
(12) Patent Application Publication
(10) Pub. No.: US 2018/0361956 A1
(43) Pub. Date: Dec. 20, 2018

(54) INSTRUMENT CLUSTER WIRELESS ELECTRIC CONNECTION AND METHOD

(71) Applicant: GM GLOBAL TECHNOLOGY OPERATIONS LLC, Detroit, MI (US)

(72) Inventors: KOBI J. SCHEIM, PARDESS HANNA (IL); GREGORY M. CASTILLO, WINDSOR (CA); MASSIMO OSELLA, TROY, MI (US)

(73) Assignee: GM GLOBAL TECHNOLOGY OPERATIONS LLC, Detroit, MI (US)

(21) Appl. No.: 15/626,543

(22) Filed: Jun. 19, 2017

(51) Int. Cl. B60R 16/023; B60K 37/02; B60K 35/00; B60R 16/03; H02J 50/10; H02J 50/40

(52) U.S. Cl. CPC B60R 16/023; B60K 37/02; H02J 50/40; B60R 16/03; H02J 50/10; B60K 35/00

(57) ABSTRACT

An instrument panel and instrument cluster electrical and data interconnection are provided. An instrument panel is adapted to receive an instrument cluster, and the instrument panel includes a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal.

### TECHNICAL FIELD

This patent generally relates to instrumentation systems for a vehicle, and more particularly, this patent relates to a wirelessly powered instrument cluster system and method of wirelessly powering an instrument cluster system of a vehicle.

### BACKGROUND

Road vehicles are typically equipped with one or more instruments within the vehicle and within view of the operator of the vehicle. While instruments may be disposed in various locations within the interior of the vehicle, several instruments primary to the operation of the vehicle may be assembled together as a cluster and positioned to be easily viewed by the operator of the vehicle. Such instruments may include a speedometer, a tachometer, powertrain operating parameter indicators such as coolant temperature, oil pressure, charge state, fuel quantity and the like. Moreover, these instruments are now primarily electrically operated receiving electric power and data signals via a wired electrical connection.

In existing implementations, therefore, a direct electrical/signal connection is provided by a wiring harness from data sources and controllers disposed within the vehicle body to the instrument cluster and/or individual instruments. As the cluster may include several instruments, it may be necessary to provide either a wired signal connection for each instrument. Alternatively, each of the instruments may be coupled by way of a communication bus to one or more data sources or controllers within the vehicle. The need to provide electric power and possibly data communications to the instruments complicates the design/packaging and installation processes. Providing a wiring harness to an instrument cluster within an instrument panel assembly may be particularly complicated and can result in less than optimal results in certain situations.

Accordingly, it is desirable to provide an instrument cluster interconnection system that simplifies the connection of the instrument cluster and the vehicle electrical and controller systems. It is further desirable to provide vehicles incorporating such instrument cluster interconnection systems. Furthermore, other desirable features and characteristics of the present disclosure will become apparent from the subsequent detailed description and the appended claims, taken in conjunction with the accompanying drawings and the foregoing technical field and background.

### SUMMARY

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal.

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver may include a first coil and the second transceiver may include a second coil, the wireless power signal being inductively coupled between the first coil and the second coil.

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver and the second transceiver are operable to communicate data with the electric power signal.

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver including a first processor and the second transceiver including a second processor, wherein the first and second processors are operable to communicate data via the first and second transceivers.

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver may be configured to provide a first wireless interface to the instrument cluster via the second transceiver.

In a non-limiting exemplary embodiment, an instrument panel and instrument cluster electrical and data interconnection is provided. An instrument panel adapted to receive an instrument cluster, and the instrument panel including a first transceiver arranged to provide a wireless electric power signal. The instrument cluster is adapted to be disposed within the instrument panel, and includes a second transceiver wirelessly coupled to the first transceiver to receive the wireless electric power signal. The second transceiver is further coupled to an instrument within the instrument cluster to provide energizing electric power to the instrument responsive to the wireless electric power signal. The second transceiver may include a plurality of transceivers and the instrument cluster may include a plurality of instruments, each of the plurality of transceivers associated with an instrument of the plurality of instruments, the first transceiver providing a plurality of wireless interfaces to the plurality of transceivers.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver may include a first coil and the second transceiver may include a second coil, the wireless electric power signal being inductively coupled between the first coil and the second coil.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver and the second transceiver may be operable to communicate data with the wireless electric power signal.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver may include a first processor and the second transceiver may include a second processor, wherein the first and second processors are operable to communicate data via the first and second transceivers.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal. The first transceiver may provide a first wireless interface to the instrument cluster via the second transceiver.

In another non-limiting exemplary embodiment, a vehicle is provide that has an instrument panel including an instrument cluster. The instrument panel includes a first transceiver arranged to provide a wireless electric power signal. The instrument cluster includes a second transceiver wirelessly coupled to the first transceiver to receive the wireless electric power signal. The second transceiver is further coupled to an instrument within the instrument cluster to provide energizing electric power to the instrument responsive to the wireless electric power signal. The instrument cluster may include a plurality of instruments, the second transceiver may include a plurality of transceivers, each of the plurality of transceivers associated with an instrument of the plurality of instruments, the first transceiver providing a plurality of wireless interfaces to the plurality of transceivers

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal.

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal. The first transceiver may include a first coil and the second transceiver may include a second coil, and wherein providing the wireless electric power signal comprises inductively coupling the wireless electric power signal between the first coil and the second coil.

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal. The method may further include communicating data with the wireless electric power signal between the first transceiver and the second transceiver.

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal. The first transceiver may include a first processor and the second transceiver may include a second processor, and the method further comprises communicating data between the first and second processors via the first and second transceivers.

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal. The method may further include providing a wireless interface from the instrument panel to the instrument cluster via the first and second transceivers.

In another non-limiting example, a method of operably electrically connecting an instrument cluster with an instrument panel within a vehicle is provided. The method includes wirelessly communicating electric power and data signals from the instrument panel to the instrument cluster. The method includes providing a first transceiver operably electrically associated with the instrument panel, and providing a second transceiver operably electrically associated with the instrument cluster. The method further includes providing a wireless electric power signal from the first transceiver, and receiving the wireless electric power signal at the second transceiver. The method further includes providing energizing electric power from the second transceiver to the instrument cluster responsive to the wireless electric power signal. The method may further include providing a plurality of wireless interfaces from to the first transceiver to a plurality of second transceivers, a transceiver of the plurality of the second transceivers associated with a respective instrument of the instrument cluster.

### DESCRIPTION OF THE DRAWINGS

The exemplary embodiments will hereinafter be described in conjunction with the following drawing figures, wherein like numerals denote like elements, and wherein:

FIG. 1 is a graphic illustration of an instrument panel and instrument cluster in accordance with the herein described embodiments;

FIG. 2 is a block diagram illustration of an instrument panel and instrument cluster in accordance with the herein described embodiments;

FIG. 3 is a graphic sectional illustration of an instrument panel and instrument cluster in accordance with the herein described embodiments;

FIG. 4 is a block diagram illustration of an instrument panel and instrument cluster in accordance with another of the herein described embodiments;

FIG. 5 is a graphic sectional illustration of an instrument panel and instrument cluster in accordance with the herein described embodiments;

FIG. 6 is a schematic circuit diagram of a wireless transceiver arrangement in accordance with the herein described embodiments; and

FIG. 7 is a functional block diagram of a wireless transceiver arrangement in accordance with the herein described embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that executes one or more software or firmware programs, a combinational logic circuit, and/or other suitable components that provide the described functionality.

Exemplary embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an embodiment of the invention may employ various combinations of mechanical components and electrical components, integrated circuit components, memory elements, digital signal processing elements, logic elements, look-up tables, or the like, which may carry out a variety of functions under the control of one or more microprocessors or other control devices. In addition, those skilled in the art will appreciate that the exemplary embodiments may be practiced in conjunction with any number of mechanical and/or electronic systems, and that the vehicle systems described herein are merely exemplary embodiment of possible implementations.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

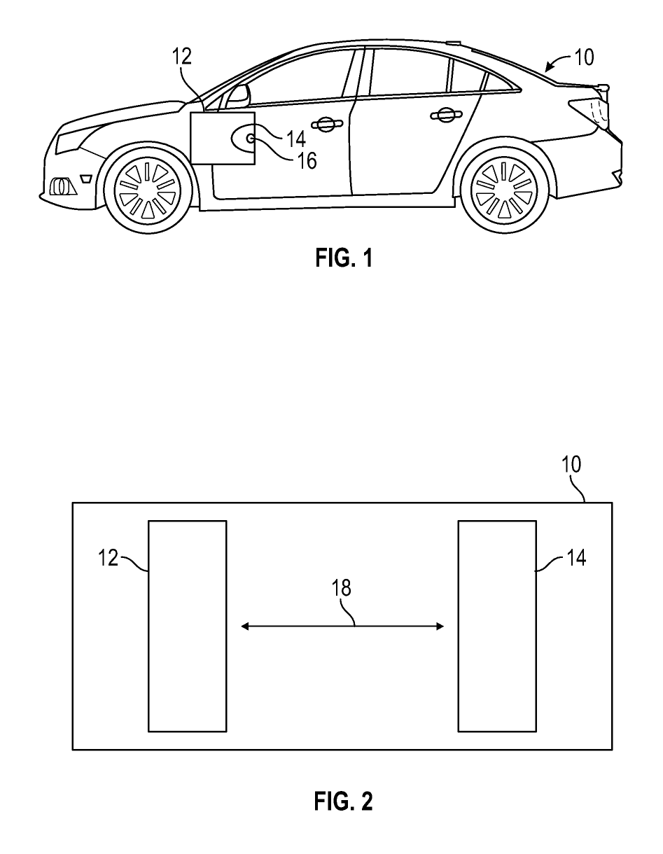

Referring to FIG. 1 a vehicle 10 includes an instrument panel 12 into which is disposed an instrument cluster 14. The instrument cluster 14 includes a variety of instrument elements, one of which is indicated as instrument 16. The instruments 16 provide an indication of an associated data relating to the operation of the vehicle 10, such as speed, engine speed, coolant temperature, oil pressure, battery charge status and fuel quantity, without limitation to various other instruments providing any number of indications.

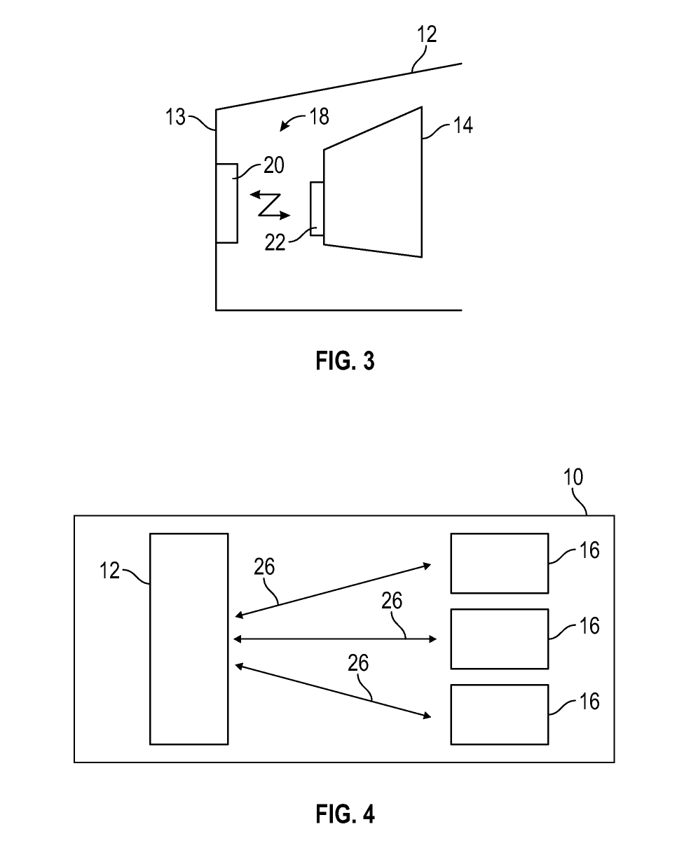

As depicted in FIGS. 2 and 3, the instrument panel 12, i.e., a body portion of the vehicle 10, includes a wireless electric power and data interface 18 to the instrument cluster 14. As depicted, the wireless interface 18 is configured to wirelessly couple electric power and data from the instrument panel 12 to the instrument cluster 14. As depicted in FIG. 3, the instrument panel 12 includes a transceiver 20, and the instrument cluster 14 includes a transceiver 22. The transceiver 20 is operably, electrically coupled to one or more data sources or controllers within the vehicle 10 to receive data to be displayed via the instrument cluster 14. The transceiver 22 is operably, electrically coupled to the various instruments 16 within the instrument cluster 14.

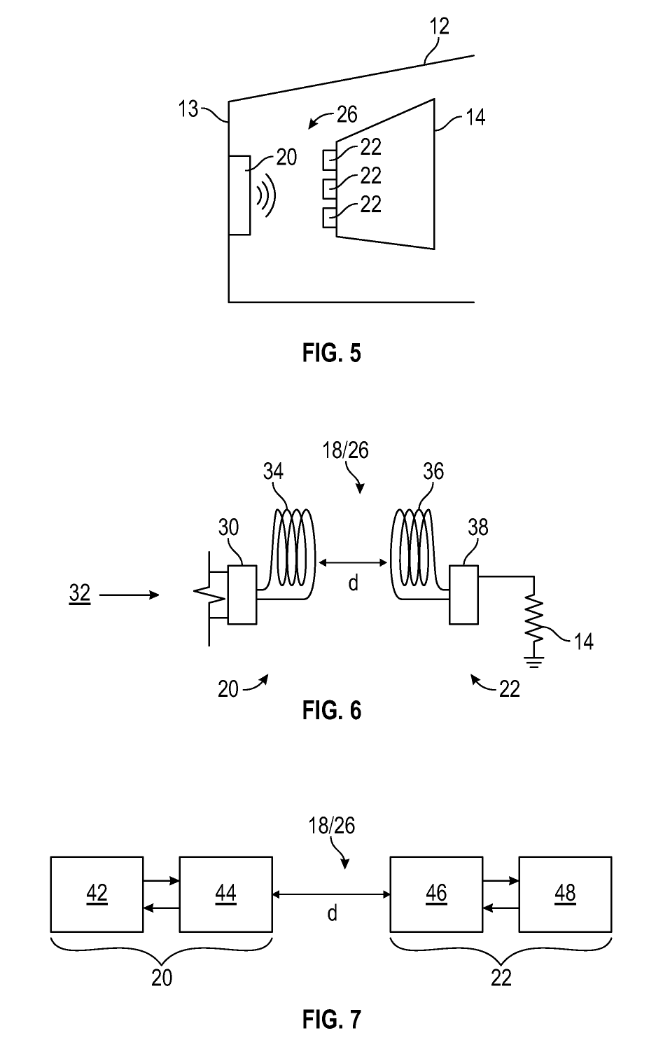

In the exemplary embodiment shown in FIGS. 4 and 5, the instrument panel 12, i.e., a body portion of the vehicle 10, includes a plurality of wireless electric power and data interfaces 26 to instruments 16 of the instrument cluster 14. As depicted, the wireless interfaces 26 are configured to be wirelessly coupled to and to receive electric power and data from the instrument panel 12 to the instruments 16 of the instrument cluster 14. As depicted in FIG. 3, the instrument panel 12 includes a transceiver 20 disposed on a substructure 13, and the instruments 16 each include a transceiver 22. The transceiver 20 is operably, electrically coupled to one or more data sources or controllers within the vehicle 10 to receive data to be displayed via an instrument 16 of the instrument cluster 14. Each transceiver 22 is operably, electrically coupled to the respective instrument 16 within the instrument cluster 14. While the wireless interfaces 26 are depicted as coupling from the instrument panel 12 to individual instruments 16, various instruments 16 may be grouped, and the wireless interfaces 26 may couple from the instrument panel 12 to one or more individual instruments 16 or groups of instruments 16 within the instrument cluster 14.

The transceivers 20 and 22 are arranged to be disposed in close proximity to each other to permit wireless capacitive coupling (electrostatic induction) between metal electrodes (not depicted), or inductive coupling (electromagnetic induction) between coils of wire (not depicted) disposed respectively within the transceivers 20 and 22. In this manner, motive electrical power may be communicated from the transceiver 20 to the transceiver 22 to energize the instrument cluster 14. The arrangement of transceiver 20 and 22 may be essentially open loop, in that transceiver 20 when energized couples power to transceiver 22 energizing the instrument cluster 14, but without providing any data or signal indication that the instrument cluster 14 is energized and operating. More typically, the transceivers 20 and 22 may be configured to communicate one or more data from the instrument panel 12 to the instrument cluster 14, and individual instruments 16 thereof, and vice-verse.

FIG. 6 depicts an exemplary arrangement of transceivers 20 and 22 utilizing inductive coupling. Transceiver 20 includes a signal generator 30 that is responsive to an input signal 32 to couple a driving signal to a primary coil 34. Transceiver 22 includes a secondary coil 36 that couples to a transformer/rectifier 38 that is coupled to provide electric power to a load 14, for example, the instrument cluster 14.

In one exemplary implementation, the coupling may be done on the magnetic plane at a suitable frequency, and for example at a frequency of 13.56 Mhz. To communicate bits of data from the transceiver 20 to the transceiver 22, a phase of the input signal 32 may be shifted. The phase shift is then detected by the transceiver 22 as a 1 or 0 bit of data. Within the transceiver 22, the load impedance may be shifted. The load impedance shift may be detected within the transceiver 20, for example as a phase shift reflection in the primary coil 34, effectively providing an ability to communicate a 1 or 0 bit of data.

The functional block diagram arrangement depicted in FIG. 7 of transceivers 20 and 22 further illustrate how the transceivers 20 and 22 may be arrange to communicate data in excess of single bits, such as control signals and data from the instrument panel 12 to the instrument cluster 14 and/or instruments 16, and control and data signals from the instrument cluster 14 and/or instruments 16 to the instrument panel 12.

As depicted, the transceiver 20 on the instrument panel 12 may be configured to include a signal processor 42 operatively coupled to a transmit/receive element 44 that includes operatively coupled the coil 34 and a transformer and a signal generator/signal detector (not depicted). The transceiver 22 associated with the instrument cluster 14 and/or instruments 16 may similarly be configured to include a transmit/receive element 46 that includes the coil 36 operatively coupled to a signal detector/generator and transformer (not depicted) coupled to a signal processor 48.

The signal processor 42 may generate one or more data to be communicated from the instrument panel 12 to the instrument cluster 14 and/or instruments 16. The data may be modulated onto the signal communicated from the element 44 to the element 46, and the data may be decoded by the signal processor 48. The data may be modulated as complex data within the communicated signal using a suitable keying method, or may be modulated as serial bits of data communicated as phase shifted signals as discussed above. Likewise, the signal processor 48 may generate one or more data to be communicated from the instrument cluster 14 and/or instruments 16 to the instrument panel 12.

Yet additional advantages arise with the use of a wireless coupling of an instrument cluster 14 to the vehicle electrical system to permit an improved installation process, as the vehicle/instrument panel transceiver 20 can be installed prior to the instrument cluster 14 installation allowing for a hidden connection, helping to hide wires and not to require wires to cross open areas, assisting in preventing damage to the wiring and improving initial product quality and long term reliability. The arrangement furthermore allows the instrument cluster 14 to be easily removed from the instrument panel 12, and potentially permits replacement and upgrading of the instrument cluster 14 over time as technology changes or improves.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. In a motor vehicle including an instrument panel and an instrument cluster, an electrical and data interconnection comprising:
the instrument panel disposed within the motor vehicle and adapted to receive securely the instrument cluster, the instrument panel including a surface upon which a first transceiver is disposed, the transceiver is arranged to provide a wireless electric power signal; and
the instrument cluster is secured within the instrument panel, the instrument cluster including a surface upon which a second transceiver is disposed, the second transceiver is arranged to wirelessly couple to the first transceiver to receive the wireless electric power signal and further being coupled to an instrument within the instrument cluster to provide energizing electric power to the instrument responsive to the wireless electric power signal, wherein
the first and second surfaces are parallel and adjacent such that the first transceiver aligns with the second transceiver to affect communication of the wireless electric power signal from the first transceiver to the second transceiver.

2. The interconnection of claim 1, the first transceiver including a first coil and the second transceiver including a second coil, the wireless power signal being inductively coupled between the first coil and the second coil.

3. The interconnection of claim 1, the first transceiver and the second transceiver operable to communicate data with the electric power signal.

4. The interconnection of claim 1, the first transceiver including a first processor and the second transceiver including a second processor, wherein the first and second processors are operable to communicate data via the first and second transceivers.

5. The interconnection of claim 1, the first transceiver configured to provide a first wireless interface to the instrument cluster via the second transceiver.

6. The interconnection of claim 1, the second transceiver comprising a plurality of transceivers and the instrument cluster comprising a plurality of instruments, each of the plurality of transceivers associated with an instrument of the plurality of instruments, the first transceiver providing a plurality of wireless interfaces to the plurality of transceivers.

7. A vehicle comprising:
a body portion including an instrument panel and an instrument cluster secured within the instrument panel, the instrument cluster including at least one instrument;
a first transceiver operably electrically coupled with the instrument panel to provide a wireless electric power signal; and
a second transceiver operably electrically coupled to the instrument cluster and further operably wirelessly coupled to the first transceiver to receive the wireless electric power signal, wherein responsive to the wireless electric power signal the second transceiver is operable to provide energizing electric power to the instrument cluster, wherein
the second transceiver is arranged in parallel, proximate relationship to the first transceiver.

8. The vehicle of claim 7, the first transceiver including a first coil and the second transceiver including a second coil, the wireless electric power signal being inductively coupled between the first coil and the second coil.

9. The vehicle of claim 7, the first transceiver and the second transceiver operable to communicate data with the wireless electric power signal.

10. The vehicle of claim 7, the first transceiver including a first processor and the second transceiver including a second processor, wherein the first and second processors are operable to communicate data via the first and second transceivers.

11. The vehicle of claim 7, the first transceiver providing a first wireless interface to the instrument cluster via the second transceiver.

12. The vehicle of claim 7, the instrument cluster comprising a plurality of instruments, the second transceiver comprising a plurality of transceivers, each of the plurality of transceivers associated with an instrument of the plurality of instruments, the first transceiver providing a plurality of wireless interfaces to the plurality of transceivers.

13. A method of electrically connecting an instrument cluster with an instrument panel within a vehicle, the method comprising:
providing a first transceiver operably electrically associated with the instrument panel;
providing a second transceiver operably electrically associated with the instrument cluster;
securing the instrument cluster within the instrument panel such that the second transceiver is arranged parallel and proximate to the first transceiver;
providing a wireless electric power signal from the first transceiver;
receiving the wireless electric power signal at the second transceiver; and
providing energizing electric power from the second transceiver to the instrument cluster responsive to the wireless electric power signal.

14. The method of claim 13, the first transceiver including a first coil and the second transceiver including a second coil, and wherein providing the wireless electric power signal comprises inductively coupling the wireless electric power signal between the first coil and the second coil.

15. The method of claim 13, further comprising communicating data with the wireless electric power signal between the first transceiver and the second transceiver.

16. The method of claim 13, the first transceiver including a first processor and the second transceiver including a second processor, and the method further comprises communicating data between the first and second processors via the first and second transceivers.

17. The method of claim 13, further comprising providing a wireless interface from the instrument panel to the instrument cluster via the first and second transceivers.

18. The method of claim 13, further comprising providing a plurality of wireless interfaces from to the first transceiver to a plurality of second transceivers, a transceiver of the plurality of the second transceivers associated with a respective instrument of the instrument cluster.
